(19) United States
(12) Patent Application Publication
(10) Pub. No.: US 2024/0192971 A1
(43) Pub. Date: Jun. 13, 2024

(54) DISPLAY CONTROL DEVICE, DISPLAY CONTROL METHOD, AND DISPLAY CONTROL PROGRAM

(71) Applicant: Nippon Telegraph and Telephone Corporation, Tokyo (JP)

(72) Inventors: Taisuke WAKASUGI, Musashino-shi, Tokyo (JP); Tomonori MORI, Musashino-shi, Tokyo (JP); Masashi Tadokoro, Musashino-shi, Tokyo (JP); Akira KATAOKA, Musashino-shi, Tokyo (JP); Haruo OISHI, Musashino-shi, Tokyo (JP)

(21) Appl. No.: 18/287,942

(22) PCT Filed: May 12, 2021
(86) PCT No.: PCT/JP2021/018126

§ 371 Date: Oct. 23, 2023

(51) Int. Cl. G06F 9/451

(52) U.S. Cl. CPC G06F 9/451

(57) ABSTRACT

Page A display control device acquires information on an existing UI constituting a screen of a web system that is subject to display control. The display control device acquires UI information of an extended UI for the existing UI from a rule set of the existing UI stored in a DB. Then, the display control device sets a rule for the extended UI based on the acquired UI information of the extended UI, and displays the extended UI. When the rule of the extended UI is to be corrected after the extended UI is displayed, the display control device adds correction information to a rule set including the UI information of the extended UI. When a rule is to be set for the extended UI on the screen of a new web system, the display control device sets a rule based on the rule set to which the correction information is added.

### TECHNICAL FIELD

The present invention relates to a display control device, a display control method, and a display control program for a screen of a web system.

### BACKGROUND ART

In the past, for the purpose of supporting a user's operations on a screen of a web system, there is a technology in which a UI for extension (extended UI) for supporting a user's operations is provided separately from a UI (existing UI) provided on a screen of a web system and the extended UI is overlaid on the existing UI on the screen. Then, when a user's operation is received, the extended UI transfers the content of the operation to the existing UI corresponding to the extended UI. Thus, the web system can process the user's operation as if the operation were executed on the existing UI (refer to PTL 1).

In this case, rules on the input operation are set for each extended UI so that a user can perform an appropriate input operation on the screen of the web system. For example, when information that can be input to the existing UI on the screen of the web system is limited, the extended UI for displaying the information that can be input in a pull-down menu is provided as an extended UI corresponding to the existing UI. In addition, when a user's selection input is received from the pull-down menu, the extended UI transfers the selected information to the existing UI. With this configuration, a user's operations on the screen of the web system can be supported without modifying the web system itself.

### CITATION LIST

### Patent Literature

[PTL 1] Japanese Patent Application Publication No. 2017-072872

### SUMMARY OF INVENTION

### Technical Problem

In that case, it takes time and effort to create an extended UI from scratch for the screen of a new web system. For this reason, the extended UI that was associated with each existing UI on the screen of the web system in the past is recorded. In addition, the use frequency of each extended UI is also recorded. Thus, it is conceivable to automatically create an extended UI having a high use frequency by referring to the record when an extended UI for the screen of a new web system is to be created. However, an extended UI having a high use frequency is not appropriate at all times depending on the type and use method of the screen of the new web system.

Thus, the present invention aims to solve the above problem, and to automatically create an appropriate extended UI for a screen of a web system.

### Solution to Problem

Therefore, the present invention includes an acquisition unit that acquires information of a user interface (UI) constituting a screen of a web system to be subject to display control, an extraction unit that extracts, from a database storing a rule set indicating information of the UI constituting the screen of the web system associated with UI information indicating a rule on display and an input operation of an extended UI of the UI, a rule set of the acquired UI, a generation unit that generates a rule to be set for an extended UI of the UI constituting the screen of the web system by using UI information of an extended UI indicated by the extracted rule set of the UI, a setting unit that sets the generated rule for an extended UI of the UI, a display processing unit that displays the extended UI of the UI based on the setting, and a rule set update unit that adds, when the rule of the extended UI is to be corrected after the extended UI is displayed, UI information of an extended UI in which content of the correction is reflected to the rule set including the UI information of the extended UI to be corrected in the database.

### Advantageous Effects of Invention

According to the present invention, an appropriate extended UI can be automatically created on a screen of a web system.

### BRIEF DESCRIPTION OF DRAWINGS

FIG. 1 is a diagram for describing an overview of an operation of a display control device.

FIG. 2 is a diagram for describing an overview of an operation of the display control device.

FIG. 3 is a diagram for describing an operation example of the display control device when the device accepts correction of an extended UI.

FIG. 4 is a diagram illustrating a configuration example of a system including the display control device.

FIG. 5 is a diagram illustrating an example of a procedure for creating a rule set by the display control device.

FIG. 6 is a flowchart showing an example of a processing procedure of the display control device.

FIG. 7 is a diagram illustrating an example of a computer that executes a display control program.

### DESCRIPTION OF EMBODIMENTS

A mode (embodiment) of the present invention will be described below with reference to the drawings. Further, the present invention is not limited to the embodiment described below.

### [Extended UI]

An extended user interface (UI) in this embodiment is overlaid on an existing UI (a UI originally provided in a web system) constituting the screen of a web system when displayed. In addition, when an extended UI receives a user's operation, the content of the operation is transferred to the existing UI corresponding to the extended UI. Then, the web system performs processing based on the content of the operation transferred to the existing UI. Thus, the web system performs processing as if the user's operation were executed on the existing UI. This extended UI is realized using, for example, the technique described in PTL 1.

### [Overview]

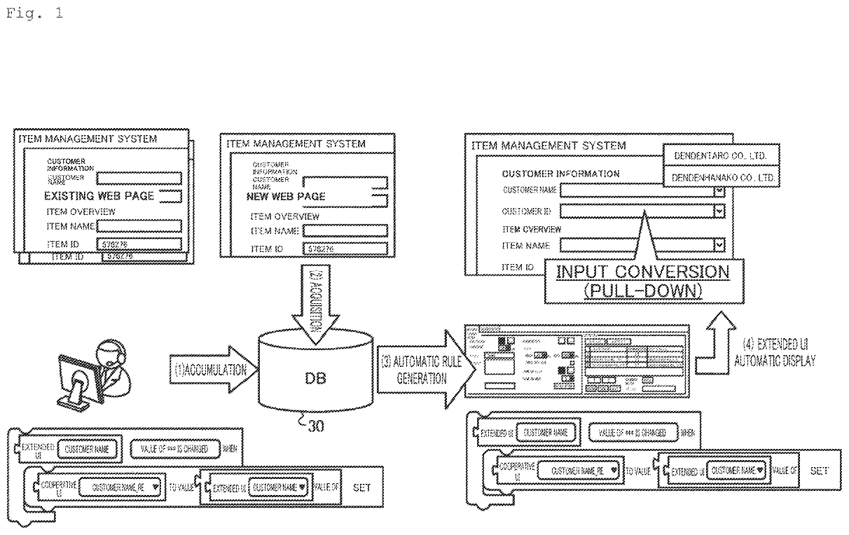

Referring to FIG. 1, the outline of the operation of the display control device according to the present embodiment will be described. For example, the user of the display control device first accumulates a rule set (details will be described later) indicating UI information of an extended UI corresponding to an existing UI constituting a screen (web page) of a web system for each existing UI in a DB (database) 30 (see (1) of FIG. 1). The UI information is information indicating a rule related to display and input operations of the UI, and includes, for example, a type of UI (existing UI/extended UI), a UI format UI (button, text, etc.), an event set in the UI (click, change, etc.), etc.

Next, when reading a new web page of the web system, the display control device acquires information of an existing UI constituting the web page (refer to (2) of FIG. 1). Then, the display control device acquires a rule set of the existing UI from the DB 30 by using the acquired information of the existing UI as a key.

Then, the display control device automatically generates the rule of the extended UI corresponding to the existing UI of the new web page based on the acquired rule set (refer to (3) of FIG. 1). The rule of the extended UI is a rule related to display and input operations of the extended UI on a screen of a web system, and for example, when a value of a customer name is changed by a pull-down menu of the extended UI, this rule is a rule for setting the value of the customer name in the cooperative UI (existing UI). Then, the display control device automatically displays the extended UI on the existing UI on the new web page by using the generated rule of the extended UI (refer to (4) of FIG. 1).

Thus, as illustrated in FIG. 1, the display control device applies the rule of the extended UI for executing pull-down to a text box of the existing UI of “customer name” on an “item management system” screen as a new web page, which makes the pull-down input of “Dendentaro Co., Ltd.” and “Dendenhanako Co., Ltd.”.

Further, the display control device may add the generated UI information of the extended UI to the rule set of the existing UI in the DB 30 after automatically generating the extended UI corresponding to the existing UI as described above.

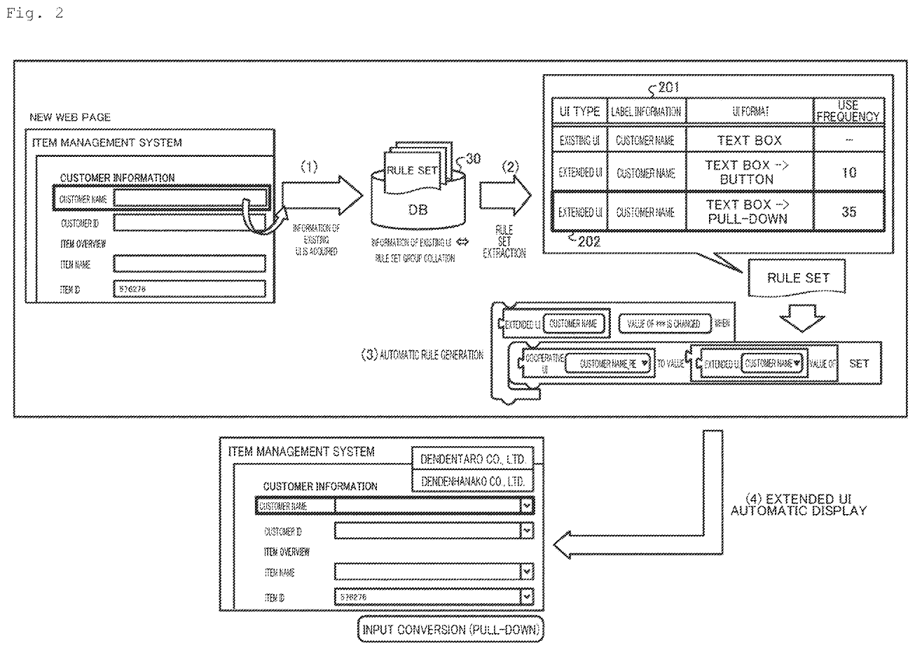

Referring to FIG. 2, the outline of the operation of the display control device will be described in detail. For example, when the display control device acquires information of an existing UI constituting a new web page (refer to (1) in FIG. 2), the display control device collates the information of the existing UI with a rule set group in the DB 30, and extracts the rule set of the existing UI (see (2) of FIG. 2). Then, the display control device automatically generates the rule of the extended UI (see (3) of FIG. 2) based on the UI information of the extended UI illustrated in the extracted rule set (see reference numeral 201 of FIG. 2).

### [Rule Set]

Further, in the rule set, for example, UI information of an extended UI corresponding to an existing UI (for example, label information of the extended UI, a UI format, or the like), and use frequency of the extended UI are recorded as indicated by reference numeral 201 of FIG. 2. The value of the use frequency is incremented, for example, each time the extended UI is operated.

For example, when UI information of a plurality of extended UIs is included in a rule set of an existing UI extracted by the display control device as indicated by reference numeral 201 in FIG. 2, UI information of the extended UI (for example, UI information of the extended UI indicated by reference numeral 202) is selected based on the level of use frequency of each extended UI. Then, the display control device automatically generates a rule of the extended UI corresponding to the existing UI by using the UI information of the selected extended UI (refer to (3) of FIG. 2), and automatically displays the extended UI by using the generated rule of the extended UI (refer to (4) of FIG. 2). In this way, the display control device can automatically display the extended UI which is more appropriate to display on the screen of the web system.

### [Correction of Extended UI]

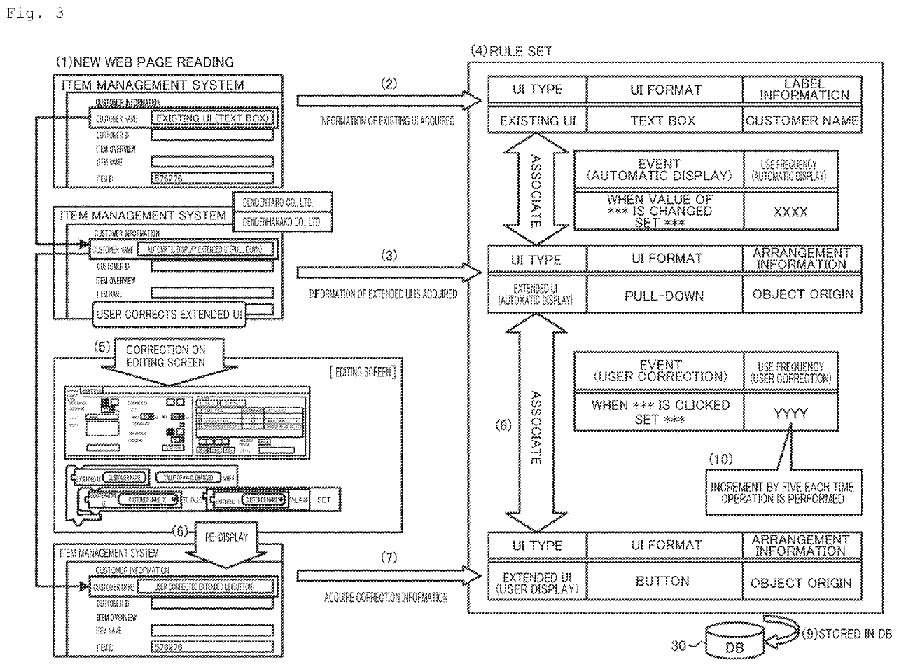

However, the extended UI automatically displayed as described above is not always suitable for the web system. For this reason, the display control device may accept correction of the extended UI from a user (see (5) of FIG. 3).

In such a case, the display control device acquires correction information of the extended UI from the user (see (7) of FIG. 3), and associates the correction information (UI information of the corrected extended UI) with UI information of the extended UI in the rule set (see (8) of FIG. 3).

Thus, for example, when the display control device generates the rule of the extended UI of the new web page again, the rule of the extended UI can be automatically generated based on a rule set including UI information of the extended UI corrected by the user in the past. As a result, the display control device can easily automatically display an appropriate extended UI on a screen of the web system.

That is, since the display control device feeds back the correction information to the rule set when the user corrects the extended UI, it becomes easier to automatically display an appropriate extended UI on the screen of the web system.

### [Configuration of Display Control Device]

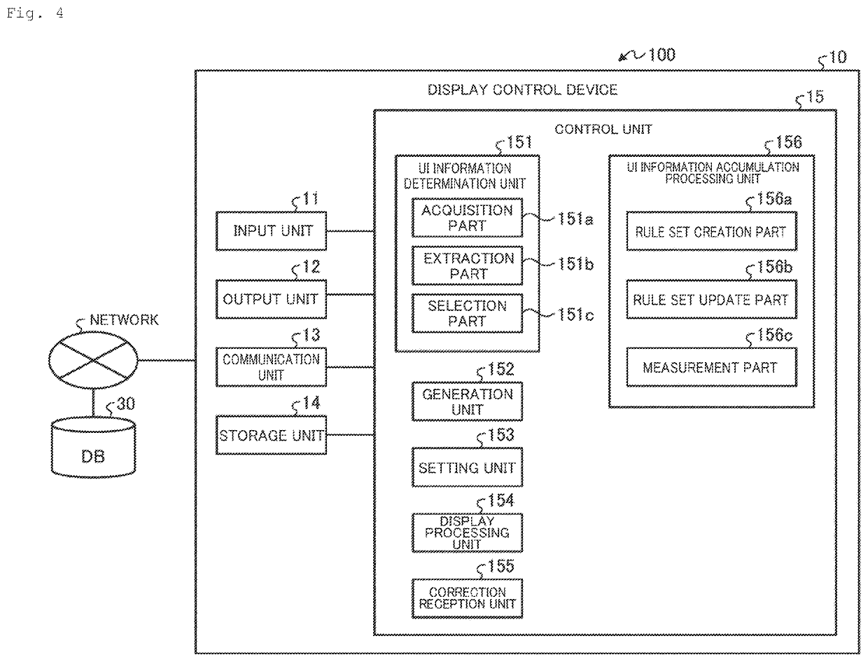

A configuration example of a system including the display control device 10 according to the present embodiment will be described with reference to FIG. 4.

A display control system 100 includes a display control device 10 and a DB 30. The display control device 10 and the DB 30 are communicatively connected via a network, for example.

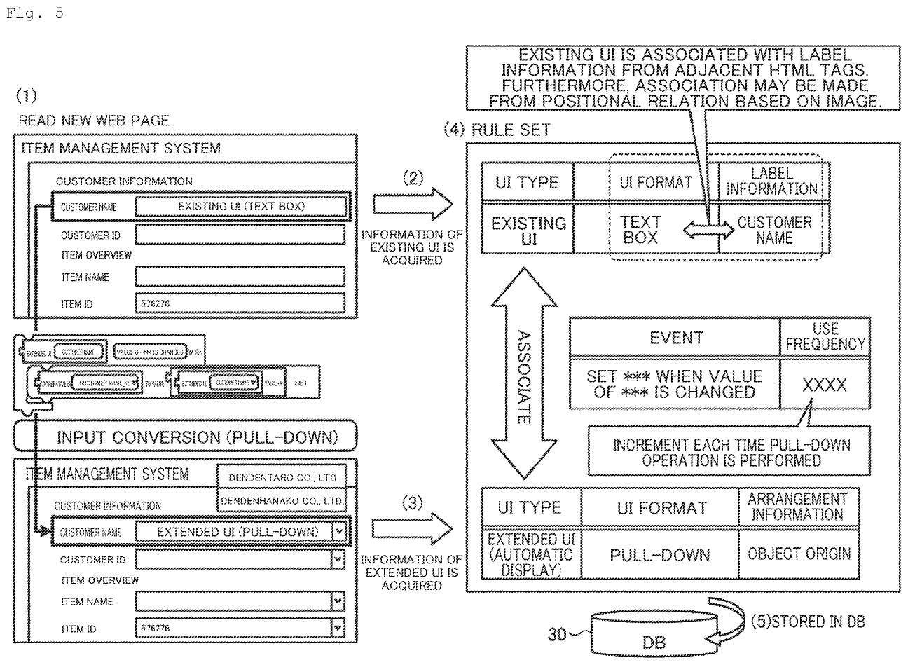

The DB 30 accumulates a rule set of each existing UI created by the display control device 10. The rule set is, for example, information in which the UI information of the existing UI is associated with the UI information of the extended UI of the existing UI as illustrated in FIG. 5.

The UI information of the existing UI is information indicating, for example, a type of UI (existing UI), a UI format (for example, text box, or the like) of the existing UI, label information (for example, customer name) of the existing UI, and the like. For example, upon acquiring HTML data of an existing UI of a web page, the display control device 10 associates the existing UI with label information from an adjacent HTML tag. Further, the display control device 10 may perform the above-mentioned association from the position information based on an image of the web page.

In addition, the UI information of the extended UI is information indicating a rule related to display and input operations of the extended UI, and for example, includes a type of UI (extended UI), a format of the extended UI (button, text, or the like), an event set in an extended UI (click, change or, the like), and the like.

For example, with respect to the rule set illustrated in FIG. 5, the UI format of the extended UI associated with the existing UI (UI format: text box, label information: customer name) is “pull-down”, the arrangement information of the extended UI is “object base point”, and the event set in the extended UI indicates “setting of *** when value of *** is changed”.

In addition, the rule set includes a value of the use frequency of each extended UI. The value of the use frequency is incremented, for example, each time the extended UI is operated. For example, when the UI format of the extended UI illustrated in the rule set is “pull-down”, the value of the use frequency is incremented each time a pull-down operation is performed on the extended UI on the screen of the web system as illustrated in FIG. 5.

In addition, although the DB 30 is described as being arranged in the display control device 10, the present invention is not limited thereto. For example, it may be arranged in the display control device 10. In addition, the DB 30 may be shared by a plurality of display control devices 10.

The display control device 10 includes an input unit 11, an output unit 12, a communication unit 13, a storage unit 14, and a control unit 15.

The input unit 11 controls input of various types of information into the display control device 10. The input unit 11 is, for example, a mouse, a keyboard, or the like. In addition, the output unit 12 controls output of various types of information from the display control device 10. The output unit 12 is, for example, a display or the like, and outputs a screen of a web system, an existing UI on the screen, an extended UI, or the like. The communication unit 13 controls data communication with another device. For example, the communication unit 13 performs data communication with the DB 30 through a network.

The storage unit 14 stores various types of information which is referred to when the control unit 15 operates and various types of information obtained when the control unit 15 operates. Here, the storage unit 14 is, for example, a semiconductor memory device such as a random access memory (RAM), or a flash memory, or a storage device such as a hard disk or an optical disc. Further, although the storage unit 14 is installed inside the display control device 10 in the example illustrated in FIG. 4, it may be installed outside the display control device 10.

The control unit 15 controls the entire display control device 10. The control unit 15 includes a UI information determination unit 151, a generation unit 152, a setting unit 153, a display processing unit 154, a correction reception unit 155 and a UI information accumulation processing unit 156.

The UI information determination unit 151 determines UI information for displaying an extended UI on a screen (a new web page) of a web system. This UI information determination unit 151 includes an acquisition part 151a, an extraction part 151b, and a selection part 151c.

By reading a screen (a new web page) of a web system, the acquisition part 151a acquires information of an existing UI constituting the new web page. For example, the acquisition part 151a acquires, as information of an existing UI constituting a new web page, information such as a UI format: text box or label information: customer name.

The extraction part 151b extracts a rule set of the existing UI from the DB 30 based on the information of the existing UI acquired by the acquisition part 151a. For example, the extraction part 151b uses the information (UI format: text box, label information: customer name) of the existing UI acquired by the acquisition part 151a as a key to extract a rule set of the existing UI (see reference numeral 201 in FIG. 2) from the DB 30.

The selection part 151c selects UI information used for generating a rule of the extended UI of the existing UI from the UI information of the extended UI indicated by the rule set (see reference numeral 201 in FIG. 2) of the existing UI extracted by the extraction part 151b. For example, the selection part 151c selects UI information (see reference numeral 202 in FIG. 2) having the highest value of use frequency from a UI information group of the extended UI indicated by the rule set (see reference numeral 201 in FIG. 2) extracted by the extraction part 151b. Further, when there is only one piece of UI information of the extended UI indicated by the rule set, the selection part 151c selects the UI information of the extended UI.

In addition, when there are a plurality of pieces of UI information of the extended UI having the highest value of use frequency in the rule set extracted by the extraction part 151b, the selection part 151c may output the displayable UI formats of the extended UI via the output unit 12, and select the UI information of the extended UI of the UI format selected by the user from the UI formats.

The generation unit 152 generates a rule related to display and input operations of the extended UI. For example, the generation unit 152 generates a rule related to display and input operations of the extended UI of the extended UI based on the UI information of the extended UI selected by the selection part 151c.

For example, when the UI information of the extended UI selected by the selection part 151c is UI information indicated by the rule set of FIG. 5, the generation unit 152 generates a rule indicating “label information: customer name, UI format: text box->button, event: set *** when the value of *** is changed” or the like based on the UI information as a rule of the extended UI.

The setting unit 153 sets the rule generated by the generation unit 152 in the extended UI of the existing UI acquired by the acquisition part 151a. The information of the rule set in the extended UI by the setting unit 153 is stored in the storage unit 14, for example. The display processing unit 154 displays the extended UI based on the rule of the extended UI set by the setting unit 153.

The correction reception unit 155 receives correction of the extended UI. For example, when a correction reception unit 155 receives correction to the extended UI displayed by the display processing unit 154, the correction content is reflected on the rule of the extended UI stored in the storage unit 14. Then, the display processing unit 154 re-displays the extended UI based on the corrected rule.

The UI information accumulation processing unit 156 performs a UI information accumulation process. The UI information accumulation processing unit 156 includes a rule set creation part 156a, a rule set update part 156b, and a measurement part 156c.

The rule set creation part 156a creates a rule set (see FIG. 5). Referring to FIG. 5, the processing procedure of the rule set creation part 156a will be described. First, the rule set creation part 156a reads a new web page used for creating a rule set through the input unit 11 (see (1) of FIG. 5).

Further, the web page to be read here is a web page in which an extended UI has already been set. The extended UI of the web page may be set based on the UI information of the extended UI selected by the selection part 151c or may be set manually by a user.

Next, the rule set creation part 156a acquires information of the existing UI and information of the extended UI from the read web page. For example, the rule set creation part 156a acquires UI formats (for example, text box) and label information (for example, customer name) of a plurality of existing UIs included in a web page as information of the existing UI (see (2) of FIG. 5). In addition, the rule set creation part 156a acquires, as the information of the extended UI, a UI format (for example, pull-down) of the extended UI corresponding to each of the existing UIs of the web page, arrangement information (for example, object origin), an event set in the extended UI (for example, set when the value of *** is changed), and the like (see (3) of FIG. 5).

Then, the rule set creation part 156a creates a rule set by using the acquired information of the existing UI and information of the extended UI (see (4) of FIG. 5). For example, the rule set creation part 156a creates a rule set for associating UI information of the existing UI such as a UI format (for example, text box) and label information (for example, customer name) of the existing UI with the UI information of the extended UI such as a UI format (for example, pull-down), arrangement information (for example, object origin), and an event (for example, set *** when the value of **** is changed) of the extended UI. Then, the rule set creation part 156a accumulates the generated rule set in the DB 30 (see (5) of FIG. 5).

Description returns to FIG. 4. When the correction reception unit 155 receives correction of the extended UI, the rule set update part 156b associate the UI information of the extended UI to be corrected in the rule set with the UI information of the corrected extended UI to be added. Referring to FIG. 3, the processing procedure of the rule set update part 156b will be described. Since the processes of (1) to (4) of FIG. 3 are similar to those of (1) to (4) of FIG. 5, description thereof is omitted, and description will be provided from (5) of FIG. 3.

Here, a case in which the extended UI is automatically displayed based on the rule set generated by the processes of (1) to (4) of FIG. 5 and a user corrects the extended UI will be considered. In this case, when the correction reception unit 155 receives correction of the extended UI on the editing screen of the extended UI, the correction content is reflected on the rule of the extended UI stored in the storage unit 14 (see (5) of FIG. 3). Then, the display processing unit 154 redisplays the extended UI based on the corrected rule (see (6) of FIG. 3).

Thereafter, the rule set update part 156b acquires the correction content (correction information) of the extended UI received by the correction reception unit 155 (see (7) of FIG. 3). Then, the rule set update part 156b associates UI information based on the correction information with the UI information of the extended UI in the rule set (see (8) of FIG. 3).

For example, a case in which an extended UI for receiving a pull-down operation from a user is corrected to receive a button operation will be considered. In this case, when acquiring correction information of the extended UI from the correction reception unit 155, the rule set update part 156b associates the UI information of the extended UI (UI format: button, arrangement information: object origin, event: set *** when *** is clicked) based on the acquired correction information with the UI information of the extended UI in the rule set (UI format: pull-down, arrangement information: object origin, event: set *** when the value of *** is changed). Then, the rule set update part 156b stores the rule set in which the UI information of the extended UI based on the correction information is associated in the DB 30 (see (9) of FIG. 3).

Further, a value of use frequency is also given to the UI information of the extended UI based on the correction information. The value of use frequency is also incremented, for example, by performing an operation (use) on the extended UI. In addition, the value to be incremented here is set to be larger than the value to be incremented when an operation is performed on the automatically displayed extended UI. For example, when one operation is performed on the automatically displayed extended UI, whereas the value of use frequency is incremented by 1, when one operation is performed on the corrected extended UI, the value of use frequency is incremented by 5 (see (10) of FIG. 3).

Further, when the UI information of the extended UI based on the correction information is added to the rule set, the rule set update part 156b imparts identification information indicating that the UI information is based on the correction of the user. For example, as illustrated in FIG. 3, information such as “extended UI (user correction)” is given to the UI type in the UI information of the extended UI.

The measurement part 156c measures the number of operations of the extended UI, and imparts a value of use frequency to the UI information of the extended UI according to the measured number of operations. For example, the measurement part 156c measures the number of operations to each extended UI, and increments the value of use frequency of the UI information of the extended UI according to the measured number of operations. For example, the measurement part 156c increments the value of use frequency of the extended UI in the rule set illustrated in FIG. 5 by 1 each time a pull-down operation is performed to the extended UI of pull-down.

Further, the measurement part 156c sets a value to be incremented per one operation on the extended UI corrected by the user to be larger than a value to be incremented per one operation on the automatically displayed extended UI. For example, when a value to be incremented per one operation on the automatically displayed extended UI is 1, the measurement part 156c sets a value to be incremented by 5 per one operation on the extended UI corrected by the user (see (10) in FIG. 3).

With this operation, even when the number of operations on the automatically displayed extended UI is the same as the number of operations on the extended UI corrected by the user, the value of use frequency of the corrected extended UI is greater. As a result, when the selection part 151c selects UI information used for generating the extended UI of a new web page based on the level of use frequency imparted to the UI information of each extended UI, the UI information of the extended UI corrected by the user is easily selected. Thus, the display control device 10 easily automatically generates an appropriate extended UI when generating an extended UI of a new web page.

### [Example of Processing Procedure]

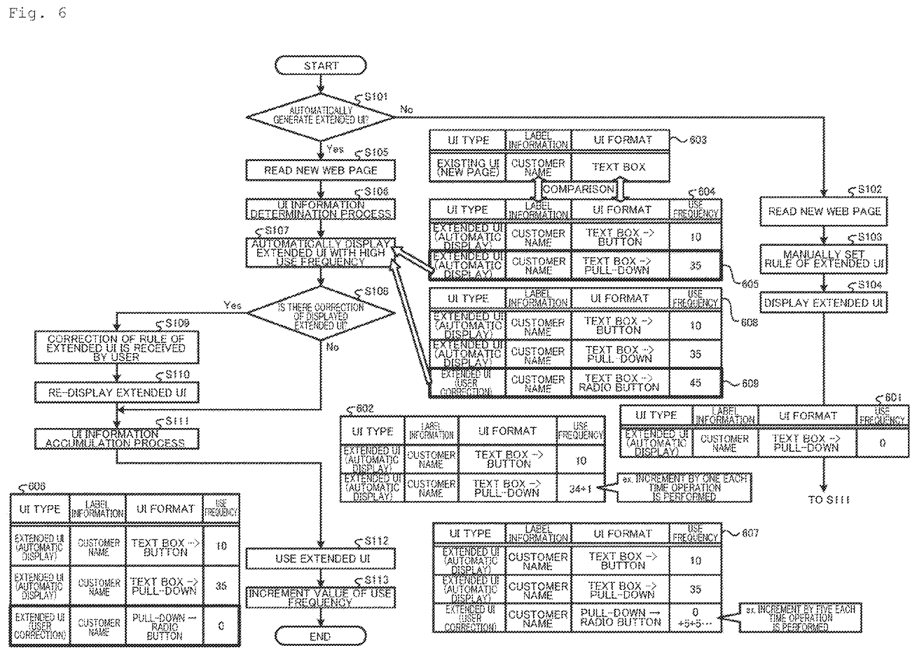

Next, an example of a processing procedure of the display control device 10 will be described with reference to FIG. 6. Further, it is assumed that the display control device 10 has received a selection input as to whether to automatically generate an extended UI of a new web page in advance.

When the display control device 10 determines that an extended UI of a new web page is not automatically generated (No in S101), the new web page is read (S102). Then, the display control device 10 manually sets a rule of an extended UI of the new web page (S103). That is, the generation unit 152 of the display control device 10 generates a rule of an extended UI of the new web page based on an input instruction from a user. Then, the setting unit 153 sets a rule of the generated extended UI. Thereafter, the display processing unit 154 displays the extended UI of the new web page based on the set rule of the extended UI (S104).

After S104, the UI information accumulation processing unit 156 performs UI information accumulation process (S111: UI information accumulation process). That is, the rule set creation part 156a of the UI information accumulation processing unit 156 creates a rule set by associating UI information of an existing UI constituting the new web page with the UI information of the extended UI displayed in S104.

For example, the rule set creation part 156a creates a rule set including UI information of an extended UI indicated by reference numeral 601. Then, the rule set creation part 156a stores the created rule set in the DB 30.

After S111, each time the extended UI is used (operated) (S112), the measurement part 156c increments the value of use frequency of the extended UI in the rule set (S113).

For example, the measurement part 156c increments the value of use frequency of the extended UI in the rule set indicated by reference numeral 602 by 1 each time the extended UI (label information: customer name, UI format: text box->pull-down) is operated.

On the other hand, when it is determined that the display control device 10 automatically generates the extended UI of the new web page in S101 (Yes in S101), the UI information determination unit 151 of the display control device 10 reads the new web page (S105). Then, the UI information determination unit 151 compares the new web page with the rule set stored in the DB 30 to determine UI information of the extended UI to be displayed on the new web page (S106: UI information determination process).

For example, the UI information determination unit 151 uses information of an existing UI of the new web page indicated by reference numeral 603 (label information: customer name, UI format: text box) as a key to extract a rule set of an existing UI indicated by reference numeral 604 (label information: customer name, UI format: text box) from the DB 30.

Then, the UI information determination unit 151 selects the UI information of the extended UI indicated by reference numeral 605, which is the highest in use frequency, among UI information of the extended UIs of the rule set indicated by reference numeral 604. Then, the generation unit 152 generates a rule of the extended UI based on the UI information of the extended UI selected by the UI information determination unit 151, and the setting unit 153 sets the generated rule for the extended UI. Then, the display processing unit 154 automatically displays the extended UI based on the set rule. That is, the display processing unit 154 automatically displays the extended UI with a high use frequency (S108).

Here, when there is a change in the extended UI displayed in S108 (Yes in S108), the correction reception unit 155 receives correction of a rule of the extended UI by a user from an editing screen (S109). Then, a correction reception unit 155 corrects the rule of the extended UI stored in the storage unit 14 based on the correction content of the received rule of the extended UI. Then, the display processing unit 154 re-displays the extended UI based on the corrected rule (S110).

Thereafter, the rule set update part 156b adds the UI information of the extended UI based on the correction content to a rule set including UI information of the extended UI to be corrected (S111: UI information accumulation process). For example, the rule set update part 156b associates the UI information of the extended UI to be corrected (label information: customer name, UI format: text box->pull-down) with the UI information of the corrected extended UI (label information: customer name, UI format: pull-down->radio button) for addition in the rule set as indicated by reference numeral 606.

Thereafter, each time the extended UI is used (operated) (S112), the measurement part 156c increments the value of use frequency of the extended UI in the rule set (S113). For example, the measurement part 156c increments the value of use frequency by 5 each time the extended UI (label information: customer name, UI format: pull-down→radio button) corrected by the user is operated as indicated by reference numeral 607.

After the measurement part 156c repeats the process of S112 and S113, when the UI information determination unit 151 selects UI information of an extended UI from the rule set for the extended UIs of the new web page based on the level of use frequency, the probability of selecting UI information of the extended UI corrected by the user is increased.

For example, it is considered that the value of use frequency of each extended UI in the rule set is a value indicated by reference numeral 608 as a result of repeating the process of S112 and S113 by the measurement part 156c.

In this case, the UI information of the extended UI having the highest use frequency among the UI information of the extended UIs of the rule set indicated by reference numeral 608 is the UI information of the extended UI indicated by reference numeral 609 (which is the UI information of the extended UI corrected by the user). Therefore, the UI information determination unit 151 selects the UI information of the extended UI indicated by reference numeral 609 as UI information of the extended UI to be displayed on the new web page. Then, the generation unit 152 generates a rule of the extended UI based on the UI information of the extended UI indicated by reference numeral 609, and the setting unit 153 sets the generated rule in the extended UI. The display processing unit 154 automatically displays the extended UI based on the set rule. Thus, the extended UI based on the rule corrected by the user is automatically displayed on the new web page.

On the other hand, when there is no change in the extended UI displayed in S107 (No in S108), the UI information accumulation processing unit 156 performs a UI information accumulation process (S111: UI information accumulation process). That is, the rule set creation part 156a acquires the information of the existing UI and the information of the extended UI from the read web page. Then, the rule set creation part 156a creates a rule set by associating the acquired information of the existing UI with the information of the extended UI, and accumulates the created rule set in the DB 30.

With this operation, the display control device 10 can generate and display the extended UI of the new web page.

### Other Embodiments

Further, as a use frequency of the extended UI in the rule set, for example, a value indicating the number of line-of-sight positions of the user with respect to the extended UI measured by a sensor, or a value indicating an overlap time of a mouse pointer and the extended UI may be used. In this case, the measurement part 156c acquires the value indicating the number of line-of-sight positions of the user with respect to the extended UI measured by the sensor, or the value of the overlap time of the mouse pointer and the extended UI, and updates the value of use frequency of the extended UI in the rule set based on the acquired values.

In addition, although the case in which the measurement part 156c increments the value of use frequency by 5 each time the extended UI corrected by the user is operated has been described, the value of use frequency of the extended UI may be updated using another method (for example, a method set by a user).

### [System Configuration, Etc.]

In addition, each component of each unit illustrated in the drawings is simply a functional concept and need not necessarily be physically configured as illustrated in the drawings. In other words, the specific forms of dispersion and integration of each device are not limited to those illustrated in the drawings, and all of or a part of the forms be functionally or physically distributed or integrated in any unit depending on various loads, usage conditions, or the like. Furthermore, all or any part of each processing function performed in each device can be realized by a CPU and a program executed by the CPU, or can be realized as hardware by a wired logic.

Also, among the processes described in the foregoing embodiment, all or some of the processes described as being automatically executed may also be manually executed, and alternatively, all or some of the processes described as being manually executed may also be automatically executed using a known method. In addition, the processing procedure, the control procedure, specific names, information including various types of data and parameters that are illustrated in the above document and drawings may be arbitrarily changed unless otherwise described.

### [Program]

The display control device 10 described above can be implemented by installing a program in a desired computer as package software or on-line software. For example, by causing an information processing device to execute the above program, the information processing device can be made to function as the display control device 10 of each embodiment. The information processing device which is described here includes a desktop type or notebook type personal computer. In addition, the information processing device includes a mobile communication terminal such as a smart phone, a mobile phone, and a personal handyphone system (PHS), a terminal such as a personal digital assistant (PDA), or the like in its category.

In addition, the display control device 10 may be implemented as a server device which provides a service related to the above-described processes to a client which is a terminal device used by a user. In this case, the server device may be implemented as a web server or as a cloud that provides services related to the processes described above by outsourcing.

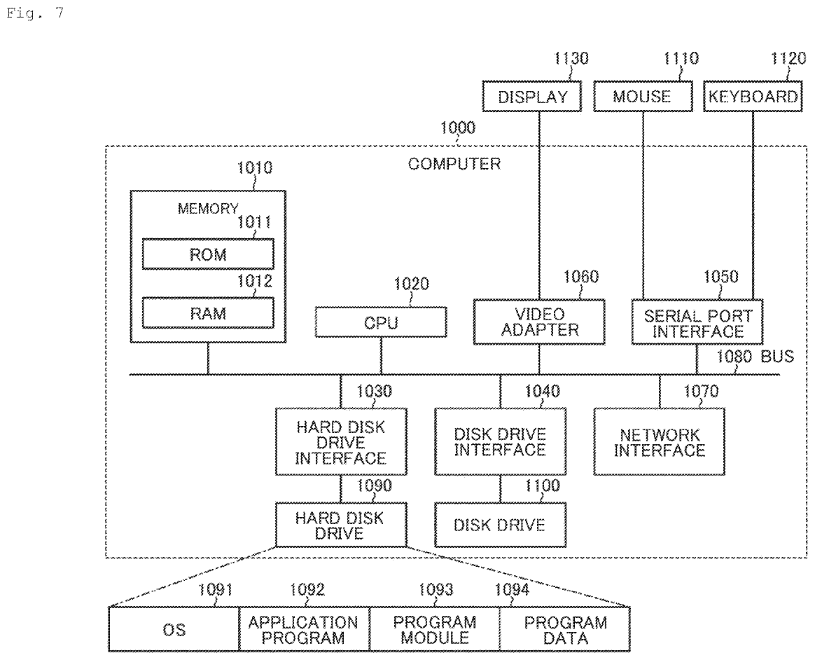

FIG. 7 is a diagram illustrating an example of a computer that executes a display control program. The computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to one another via a bus 1080.

The memory 1010 includes a read only memory (ROM) 1011 and a random access memory (RAM) 1012. The ROM 1011 stores, for example, a boot program such as a Basic Input Output System (BIOS). The hard disk drive interface 1030 is connected to the hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining each processing executed by the above-described display control device 10 is implemented as the program module 1093 in which codes that can be executed by a computer are described. The program module 1093 is stored in, for example, the hard disk drive 1090. For example, the program module 1093 for executing similar processing to the functional configuration of the display control device 10 is stored in the hard disk drive 1090. Further, the hard disk drive 1090 may be replaced with a solid state drive (SSD).

Furthermore, data used in the processing of the embodiment described above is stored, for example, in the memory 1010 or the hard disk drive 1090 as the program data 1094. In addition, the CPU 1020 reads the program module 1093 and the program data 1094 stored in the memory 1010 or the hard disk drive 1090 onto the RAM 1012 and executes them as necessary.

Further, the program module 1093 and the program data 1094 are not limited to being stored in the hard disk drive 1090 and may also be stored in, for example, a removable storage medium to be read out by the CPU 1020 via the disk drive 1100 or the like. Alternatively, the program module 1093 and the program data 1094 may be stored in another computer connected via a network (a local area network (LAN)), a wide area network (WAN), or the like). In addition, the program module 1093 and the program data 1094 may be read by the CPU 1020 from the other computer via the network interface 1070.

### REFERENCE SIGNS LIST

10 Display control device
11 Input unit
12 Output unit
13 Communication unit
14 Storage unit
15 Control unit
30 DB
100 Display control system
151 UI information determination unit
151a Acquisition part
151b Extraction part
151c Selection part
152 Generation unit
153 Setting unit
154 Display processing unit
155 Correction reception unit
156 UI information accumulation processing unit
156a Rule set creation part
156b Rule set update part
156c Measurement part

1. A display control device comprising one or more processors configured to perform operations comprising:
acquiring information of a user interface (UI) constituting a screen of a web system to be subject to display control;
extracting, from a database storing a rule set indicating information of the UI constituting the screen of the web system associated with UI information indicating a rule on display and an input operation of an extended UI of the UI, a rule set of the acquired UI;
generating a rule to be set for an extended UI of the UI constituting the screen of the web system by using UI information of an extended UI indicated by the extracted rule set of the UI;
setting the generated rule for an extended UI of the UI;
displaying the extended UI of the UI based on the setting; and
adding, when the rule of the extended UI is to be corrected after the extended UI is displayed, UI information of an extended UI in which content of the correction is reflected to the rule set including the UI information of the extended UI to be corrected in the database.

2. The display control device according to claim 1, wherein the operations comprising: adding the UI information of the extended UI in which the content of the correction is reflected to the rule set in association with the UI information of the extended UI to be corrected.

3. The display control device according to claim 1, wherein the operations further comprise:
measuring a number of operations of the extended UI, and imparting a value of use frequency of the extended UI to the UI information of the extended UI according to the measured number of operations;
selecting UI information to be used for generating a rule of an extended UI of the UI from the UI information of the extended UI indicated by the extracted rule set of the UI based on a magnitude of a value of use frequency of the extended UI given to the UI information of the extended UI; and
generating a rule of the extended UI by using the UI information of the extended UI.

4. The display control device according to claim 2, wherein the operations comprise:
measuring a number of operations for the extended UI, and when a value of use frequency of the extended UI is given to the UI information of the extended UI according to the measured number of operations, setting the use frequency to be incremented per operation for the corrected extended UI to be greater than a value of use frequency to be incremented per operation for the extended UI that has not been corrected.

5. A display control method executed by a display control device, the display control method comprising:
acquiring information of a user interface (UI) constituting a screen of a web system to be subject to display control;
extracting, from a database storing a rule set indicating information of the UI constituting the screen of the web system associated with UI information indicating a rule on display and an input operation of an extended UI of the UI, a rule set of the acquired UI;
generating a rule to be set for an extended UI of the UI constituting the screen of the web system by using UI information of an extended UI indicated by the extracted rule set of the UI; setting the generated rule for an extended UI of the UI;
displaying the extended UI of the UI based on the setting; and
adding, when the rule of the extended UI is to be corrected after the extended UI is displayed, UI information of an extended UI in which content of the correction is reflected to the rule set including the UI information of the extended UI to be corrected in the database.

6. A non-transitory computer readable medium storing one or more instructions causing a computer to execute:
acquiring information of a user interface (UI) constituting a screen of a web system to be subject to display control;
extracting, from a database storing a rule set indicating information of the UI constituting the screen of the web system associated with UI information indicating a rule on display and an input operation of an extended UI of the UI, a rule set of the acquired UI;
generating a rule to be set for an extended UI of the UI constituting the screen of the web system by using UI information of an extended UI indicated by the extracted rule set of the UI;
setting the generated rule for an extended UI of the UI;
displaying the extended UI of the UI based on the setting; and
adding, when the rule of the extended UI is to be corrected after the extended UI is displayed, UI information of an extended UI in which content of the correction is reflected to the rule set including the UI information of the extended UI to be corrected in the database.
